(19) United States
(12) Patent Application Publication
(10) Pub. No.: US 2026/0245800 A1
(43) Pub. Date: Aug. 20, 2026

(54) MULTILAYER CERAMIC CAPACITOR

(71) Applicant: SAMSUNG ELECTRO-MECHANICS CO., LTD., Suwon-si (KR)

(72) Inventors: Jiwon Jung, Suwon-si (KR); Hongseok Kim, Suwon-si (KR); Junil Kang, Suwon-si (KR); Seungjin Park, Suwon-si (KR); Cheolwoo Park, Suwon-si (KR)

(73) Assignee: SAMSUNG ELECTRO-MECHANICS CO., LTD., Suwon-si (KR)

(21) Appl. No.: 19/184,718

(22) Filed: Apr. 21, 2025

(30) Foreign Application Priority Data
Nov. 11, 2024 (KR) 10-2024-0159038

(51) Int. Cl. H01G 4/248; H01G 4/30

(52) U.S. Cl. CPC H01G 4/248; H01G 4/30

(57) ABSTRACT

A multilayer ceramic capacitor is disclosed that includes a body having a first surface and a second surface opposing each other in a first direction, a third surface and a fourth surface opposing each other in a second direction intersecting the first direction, and a fifth surface and a sixth surface opposing each other in a third direction intersecting both the first and second directions. The body includes a plurality of dielectric layers and a plurality of internal electrodes stacked in the first direction. An external electrode is disposed outside the body and includes a connection portion connected to the internal electrodes, a band portion connected to the connection portion and covering portions of the first, second, fifth, and sixth surfaces, and a protruding portion spaced apart from the connection portion and disposed on the band portion on each of the first, second, fifth, and sixth surfaces. The configuration reduces coating spread and suppresses a mooning phenomenon.

### CROSS-REFERENCE TO RELATED APPLICATION

This application claims priority to and the benefit of Korean Patent Application No. 10-2024-0159038 filed with the Korean Intellectual Property Office on Nov. 11, 2024, the entire contents of which are incorporated herein by reference.

### BACKGROUND

### 1. Field

The present disclosure relates to a multilayer ceramic capacitor.

### 2. Description of the Related Art

Electronic components using ceramic materials include capacitors, inductors, piezoelectric devices, varistors, thermistors, etc. Among the ceramic electronic components, multilayer ceramic capacitors (MLCCs) may be used in various electronic devices due to its advantages of being small, having high-capacity, and being easy to mount.

A multilayer ceramic capacitor may include a body that includes a plurality of dielectric layers and a plurality of internal electrodes, and external electrodes that are disposed outside the body and are connected to the internal electrodes. If it is desired to selectively form a coating layer only on an external electrode, the coating material may spread onto the side surfaces of the body. This may cause so-called mooning phenomenon, where the boundary between the external electrode and the body becomes an arc rather than a straight line.

### SUMMARY

The present disclosure provides a multilayer ceramic capacitor capable of preventing a mooning phenomenon.

A multilayer ceramic capacitor according to an embodiment may include a body that includes a first surface and second surface which oppose each other in a first direction, a third surface and a fourth surface which oppose each other in a second direction intersecting the first direction, and a fifth surface and a sixth surface which oppose each other in a third direction simultaneously intersecting both of the first direction and the second direction, and includes a plurality of dielectric layers and a plurality of internal electrodes stacked in the first direction, and an external electrode that is disposed outside the body, and the external electrode may include a connection portion that is connected to the plurality of internal electrodes, a band portion that is connected to the connection portion and covers a portion of each of the first surface, the second surface, the fifth surface, and the sixth surface, and a protruding portion that is spaced apart from the connection portion and is disposed on the band portion positioned on each of the first surface, the second surface, the fifth surface, and the sixth surface.

The protruding portion may be spaced apart from an edge of the band portion that is closer to the body.

The protruding portion may be disposed on an edge of the band portion that is closer to the body.

The band portion may include a first sub-band portion on the first surface, a second sub-band portion on the second surface, a third sub-band portion on the fifth surface, and a fourth sub-band portion on the sixth surface, and the protruding portion may include a first sub-protruding portion that is disposed on the first sub-band portion, a second sub-protruding portion that is disposed on the second sub-band portion, a third sub-protruding portion that is disposed on the third sub-band portion, and a fourth sub-protruding portion that is disposed on the fourth sub-band portion, and the first sub-protruding portion, the second sub-protruding portion, the third sub-protruding portion, and the fourth sub-protruding portion may be connected to each other.

The first sub-protruding portion and the second sub-protruding portion may protrude in a direction parallel to the first direction.

The third sub-protruding portion and the fourth sub-protruding portion may protrude in a direction parallel to the third direction.

The external electrode may further include a corner portion that connects the connection portion and the band portion.

The plurality of internal electrodes may include a plurality of first internal electrodes and a plurality of second internal electrodes disposed staggered from each other in the first direction.

The external electrode may include a first external electrode that is disposed on the third surface and connected to the plurality of first internal electrodes, and a second external electrode that is disposed on the fourth surface and connected to the plurality of second internal electrodes.

According to the multilayer ceramic capacitor according to the embodiment, a protruding portion may be disposed on a band portion of an external electrode, such that a mooning phenomenon is prevented.

### BRIEF DESCRIPTION OF THE DRAWINGS

FIG. 1 is a perspective view schematically illustrating a multilayer ceramic capacitor according to an embodiment.

FIG. 2 is a plan view of FIG. 1.

FIG. 3 is a side view of FIG. 1.

FIG. 4 is another side view of FIG. 1.

FIG. 5 is an exploded perspective view schematically illustrating the stacked structure of internal electrodes of the multilayer ceramic capacitor of FIG. 1.

FIG. 6 is a plan view schematically illustrating a first internal electrode of the multilayer ceramic capacitor of FIG. 1.

FIG. 7 is a plan view schematically illustrating a second internal electrode of the multilayer ceramic capacitor of FIG. 1.

FIG. 8 is a cross-sectional view taken along line I-l′ of FIG. 1.

FIG. 9 is a cross-sectional view taken along line II-Il′ of FIG. 1.

FIG. 10 is a partially enlarged view illustrating region A of FIG. 8.

FIG. 11 is a plan view schematically illustrating a multilayer ceramic capacitor according to another embodiment.

FIG. 12 is a schematic cross-sectional view of FIG. 11.

FIG. 13 is a schematic view illustrating a process of forming a coating layer on a multilayer ceramic capacitor according to an example.

FIG. 14 is a schematic view illustrating a process of forming a coating layer on a multilayer ceramic capacitor according to a comparative example.

### DETAILED DESCRIPTION

Hereinafter, embodiments of the present disclosure will be described in detail with reference to the accompanying drawings such that those skilled in the art can easily implement them. The drawings and description are to be regarded as illustrative in nature and not restrictive. Like reference numerals designate like elements throughout the specification. Further, some constituent elements in the drawings may be exaggerated, omitted, or schematically illustrated, and a size of each constituent element does not reflect the actual size entirely.

The accompanying drawings are provided for helping to easily understand embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including ordinal numbers, such as first and second, are used for describing various constituent elements, but the constituent elements are not limited by the terms. The terms are used only to differentiate one constituent element from another constituent element.

Furthermore, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “on” a reference portion, the element is located above or below the reference portion, and it does not necessarily mean that the element is located “above” or “on” in a direction opposite to gravity.

Throughout the specification, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Therefore, unless explicitly described to the contrary, the word “comprise”, and variations such as “comprises” or “comprising”, will be understood to imply the inclusion of stated elements but not the exclusion of any other elements.

Furthermore, throughout the specification, the expression “on a plane” refers to viewing a target part from above, while “on a cross-section” refers to viewing a vertically cut cross-section of the target part from the side.

Furthermore, throughout the specification, when it is referred to as “connected”, this does not only mean that two or more constituent elements are directly connected, but may mean that two or more constituent elements are indirectly connected through another constituent element, are physically connected, electrically connected, or are integrated even though two or more constituent elements are referred to by different names depending on a location and a function.

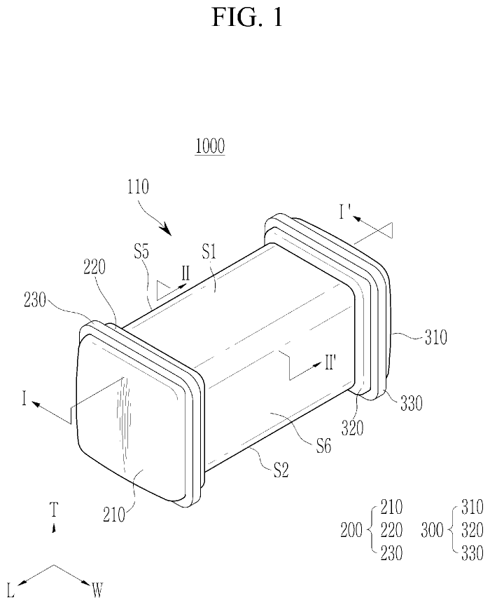

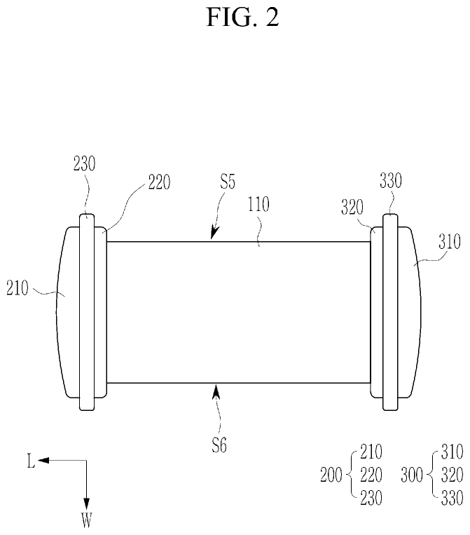

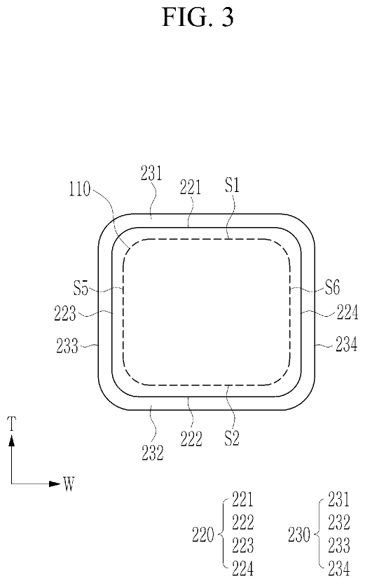

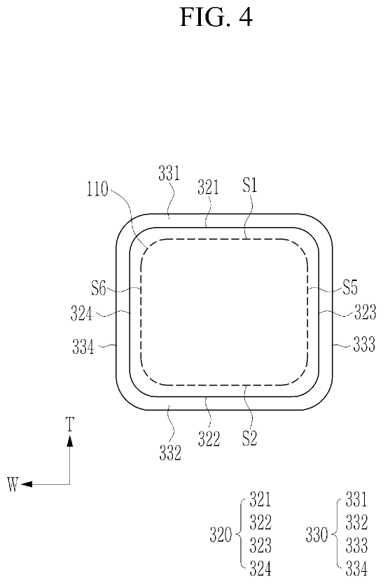

FIG. 1 is a perspective view schematically illustrating a multilayer ceramic capacitor according to an embodiment, FIG. 2 is a plan view of FIG. 1, FIG. 3 is a side view of FIG. 1, and FIG. 4 is another side view of FIG. 1.

Referring to FIGS. 1, 2, 3, and 4, a multilayer ceramic capacitor 1000 according to the present embodiment includes a body 110, a first external electrode 200, and a second external electrode 300.

First, to clearly describe the present embodiment, directions are defined. A T axis, an L axis, and a W axis shown in the drawings represent axes indicating a first direction, a second direction, and a third direction of the multilayer ceramic capacitor 1000, respectively.

The first direction (T-axis direction) may be a direction perpendicular to wide surfaces (main surfaces) of sheet-shaped constituent elements. For example, the first direction (T-axis direction) may correspond to the direction in which dielectric layers 140 are stacked. Hereinafter, for ease of explanation, the “first direction” will be referred to as a “thickness direction”.

The second direction (L-axis direction) may be a direction parallel to wide surfaces (main surfaces) of sheet-shaped constituent elements, and be a direction that intersects (or is perpendicular to) the thickness direction (T-axis direction). For example, the second direction (L-axis direction) may be a direction in which the first external electrode 200 and the second external electrode 300 oppose each other. Hereinafter, for ease of explanation, the “second direction” will be referred to as a “length direction”.

The third direction (W-axis direction) may be a direction parallel to wide surfaces (main surfaces) of sheet-shaped constituent elements, and be a direction that intersects (is perpendicular to) both of the thickness direction (T-axis direction) and the length direction (L-axis direction). Hereinafter, for ease of explanation, the “third direction” will be referred to as a “width direction”.

The body 110 may have a roughly hexahedral shape, but the present embodiment is not limited thereto. Due to shrinkage during sintering, the body 110 may have a substantially hexahedral shape, although not a perfect hexahedral shape. For example, the body 110 may have a substantially cuboidal shape, but a portion corresponding to a corner or a vertex may have a rounded shape.

In the present embodiment, for ease of explanation, surfaces opposing each other in the thickness direction (T-axis direction) of the body 110 are defined as a first surface S1 and a second surface S2, and surfaces opposing each other in the length direction (L-axis direction) of the body 110 and connecting the first surface S1 and the second surface S2 are defined as a third surface S3 and a fourth surface S4, and surfaces opposing each other in the width direction (W-axis direction) of the body 110 and connecting the first surface S1 and the second surface S2 are defined as a fifth surface S5 and a sixth surface S6.

Accordingly, the first direction in which the first surface S1 and the second surface S2 oppose each other may be the thickness direction (T-axis direction), and the second direction and the third direction which are perpendicular to the first direction and are perpendicular to each other may be the length direction (L-axis direction) and the width direction (W-axis direction), or the width direction (W-axis direction) and the length direction (L-axis direction), respectively.

Based on an optical microscope or scanning electron microscope (SEM) photograph of a cross section taken along the length direction (L-axis direction) and thickness direction (T-axis direction) at a center of the body 110 in the width direction (W-axis direction), a length of the body 110 may refer to a maximum of the lengths of a plurality of line segments connecting two outermost boundary lines opposing each other in the length direction (L-axis direction) of the body 110 shown in the above-mentioned cross section photograph, and parallel to the length direction (L-axis direction). Alternatively, the length of the body 110 may refer to a minimum of the lengths of a plurality of line segments connecting two outermost boundary lines opposing each other in the length direction (L-axis direction) of the body 110 shown in the above-mentioned cross section photograph and parallel to the length direction (L-axis direction). Alternatively, the length of the body 110 may refer to an arithmetic average of the lengths of at least two line segments among the line segments connecting two outermost boundary lines opposing each other in the length direction (L-axis direction) of the body 110 shown in the above-mentioned cross section photograph and parallel to the length direction (L-axis direction).

Based on an optical microscope photograph or scanning electron microscope (SEM) photograph of a cross section taken along the length direction (L-axis direction) and thickness direction (T-axis direction) at a center of the body 110 in the width direction (W-axis direction), a thickness of the body 110 may refer to a maximum of the lengths of a plurality of line segments connecting two outermost boundary lines opposing each other in the thickness direction (T-axis direction) of the body 110 shown in the above-mentioned cross section photograph and parallel to the thickness direction (T-axis direction). Alternatively, the thickness of the body 110 may refer to a minimum of the lengths of a plurality of line segments connecting two outermost boundary lines opposing each other in the thickness direction (T-axis direction) of the body 110 shown in the above-mentioned cross section photograph and parallel to the thickness direction (T-axis direction). Alternatively, the thickness of the body 110 may refer to an arithmetic average of the lengths of at least two line segments among the line segments connecting two outermost boundary lines opposing each other in the thickness direction (T-axis direction) of the body 110 shown in the above-mentioned cross section photograph and parallel to the thickness direction (T-axis direction).

Based on an optical microscope photograph or scanning electron microscope (SEM) photograph of a cross section taken along the length direction (L-axis direction) and width direction (W-axis direction) at a center of the body 110 in the thickness direction (T-axis direction), a width of the body 110 may refer to a maximum of the lengths of a plurality of line segments connecting two outermost boundary lines opposing each other in the width direction (W-axis direction) of the body 110 shown in the above-mentioned cross section photograph and parallel to the width direction (W-axis direction). Alternatively, the width of the body 110 may refer to a minimum of the lengths of a plurality of line segments connecting two outermost boundary lines opposing each other in the width direction (W-axis direction) of the body 110 shown in the above-mentioned cross section photograph and parallel to the width direction (W-axis direction). Alternatively, the width of the body 110 may refer to an arithmetic average of the lengths of at least two line segments among the line segments connecting two outermost boundary lines opposing each other in the width direction (W-axis direction) of the body 110 shown in the above-mentioned cross section photograph and parallel to the width direction (W-axis direction).

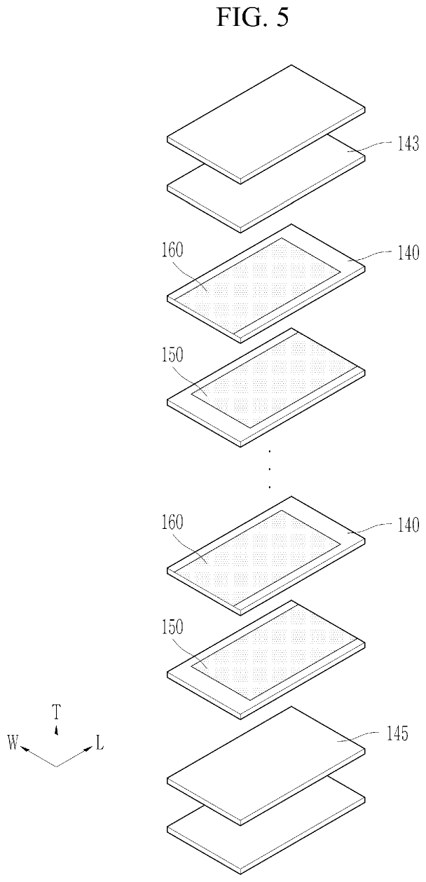

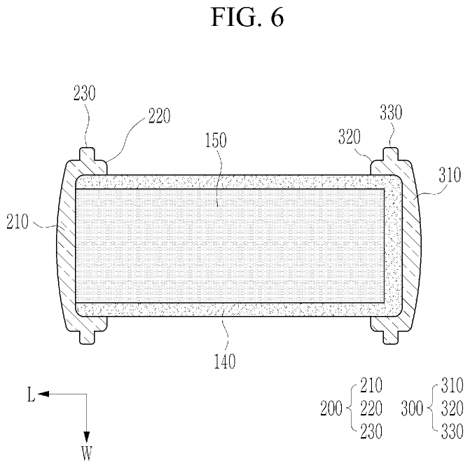

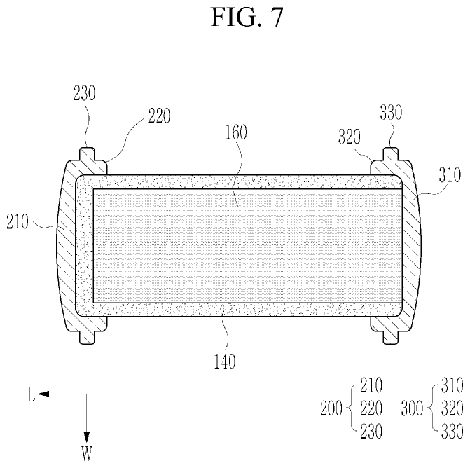

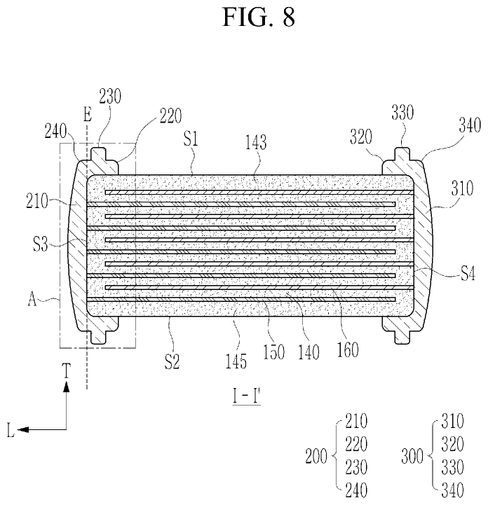

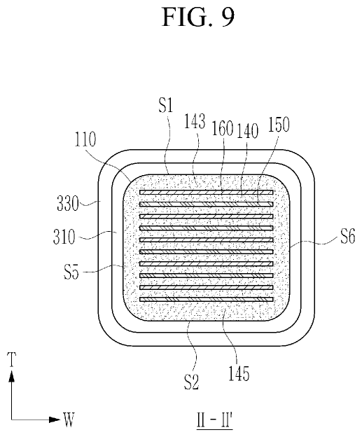

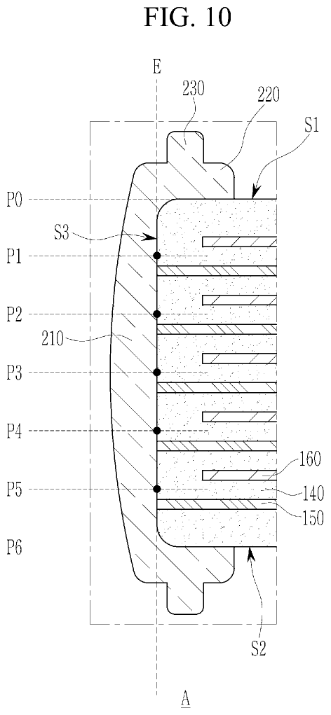

FIG. 5 is an exploded perspective view schematically illustrating the stack structure of internal electrodes of the multilayer ceramic capacitor of FIG. 1, FIG. 6 is a plan view schematically illustrating a first internal electrode of the multilayer ceramic capacitor of FIG. 1, and FIG. 7 is a plan view schematically illustrating a second internal electrode of the multilayer ceramic capacitor of FIG. 1. FIG. 8 is a cross-sectional view taken along line I-I′ of FIG. 1, FIG. 9 is a cross-sectional view taken along line II-II′ of FIG. 1, and FIG. 10 is a partial enlarged view illustrating region A of FIG. 8.

Referring to FIGS. 5, 6, 7, 8, 9, and 10, the body 110 may include a plurality of dielectric layers 140, a first internal electrode 150, and a second internal electrode 160.

The plurality of dielectric layers 140 is stacked in the thickness direction (T-axis direction) of the body 110. The boundaries between the dielectric layers 140 may be unclear. For example, it is difficult to observe the boundaries between the dielectric layers 140 without using a scanning electron microscope (SEM), and the plurality of dielectric layers 140 may appear to be an integral structure.

The dielectric layer 140 may contain a ceramic material. For example, the ceramic material may include dielectric ceramic containing components such as BaTiO₃, CaTiO₃, SrTiO₃, or CaZrO₃. Also, the dielectric layer may further contain an auxiliary component such as a manganese (Mn) compound, an iron (Fe) compound, a chromium (Cr) compound, a cobalt (Co) compound, a nickel (Ni) compound, etc., in addition to the ceramic material. For example, the dielectric layer may comprise (Ba₁₋ₓCaₓ)TiO₃ (wherein 0<x<1), Ba(Ti_{1-y}Ca_{y})O₃ (wherein 0<y<1), (Ba₁₋ₓCaₓ) (Ti_{1-y}Zr_{y})O₃ (wherein 0<x<1 and 0<y<1) or Ba (Ti_{1-y}Zr_{y})O₃ (wherein 0<y<1), or the like, in which calcium (Ca), zirconium (Zr), or the like is partially dissolved into BaTiO₃, but the present disclosure is not limited thereto.

Furthermore, the dielectric layer 140 may further contain one or more of ceramic additives, organic solvents, plasticizers, binders, and dispersants. Examples of the ceramic additives may include transition metal oxides or carbides, rare earth elements, magnesium (Mg), aluminum (Al), etc.

The first internal electrode 150 and the second internal electrode 160 may be alternately stacked with the dielectric layer 140 interposed therebetween. This stack structure may be repeated inside the body 110, and the internal electrode closest to the first surface S1 of the body 110 may be a first internal electrode 150 or a second internal electrode 160. Similarly, the internal electrode closest to the second surface S2 of the body 110 may be a first internal electrode 150 or a second internal electrode 160.

The first internal electrode 150 and the second internal electrode 160 have different polarities, and may be electrically insulated from each other by the dielectric layer 140 disposed therebetween.

The first internal electrode 150 and the second internal electrode 160 may be formed by printing a conductive paste that includes a metal on a surface of the dielectric layer 140. For example, a conductive paste including nickel (Ni) or nickel (Ni) alloy may be printed on the surface of the dielectric layer using screen printing or gravure printing to form the internal electrode. However, the embodiment is not limited thereto.

When a voltage is applied to the first external electrode 200 and the second external electrode 300, an electric charge accumulates between the first internal electrode 150 and the second internal electrode 160. In other words, capacitance may be generated between the first internal electrode 150, which is electrically connected to the first external electrode 200, and the second internal electrode 160, which is electrically connected to the second external electrode 300. Capacitance of the multilayer ceramic capacitor 1000 is proportional to an area where the first internal electrodes 150 and the second internal electrodes 160 overlap each other along the thickness direction (T-axis direction).

Referring to FIGS. 7 and 8, a first cover layer 143 and a second cover layer 145 may be disposed on the outermost side of the body 110 in the thickness direction (T-axis direction).

The first cover layer 143 is disposed between the first surface S1 of the body 110 and the internal electrode closest to the first surface S1. The second cover layer 145 is disposed between the second surface S2 of the body 110 and the internal electrode closest to the second surface S2.

That is, within the body 110, the first cover layer 143 may be disposed at an upper portion of an uppermost internal electrode, and the second cover layer 145 may be disposed at a lower portion of a lowermost internal electrode.

The first cover layer 143 and the second cover layer 145 may have the same composition as the dielectric layer 140. The first cover layer 143 and the second cover layer 145 may be formed by stacking one or more dielectric layers on an outer surface of the uppermost internal electrode and an outer surface of the lowermost internal electrode, respectively. Meanwhile, the first cover layer 143 and the second cover layer 145 may have different compositions from the dielectric layer 140.

The first cover layer 143 and the second cover layer 145 may serve to prevent damage to the first internal electrode 150 and the second internal electrode 160 by a physical or chemical stress.

The first external electrode 200 and the second external electrode 300 are disposed outside the body 110.

The first external electrode 200 may be disposed on the third surface S3 of the body 110, and may extend onto the first surface S1, the second surface S2, the fifth surface S5, and the sixth surface S6. The second external electrode 300 may be disposed on the fourth surface S4 of the body 110, and may extend onto the first surface S1, the second surface S2, the fifth surface S5, and the sixth surface S6. In another embodiment, the first external electrode 200 and the second external electrode 300 may extend onto a portion of at least one of the first surface S1 and the second surface S2.

The first external electrode 200 includes a first connection portion 210, a first band portion 220, a first protruding portion 230, and a first corner portion 240.

The first connection portion 210 covers the third surface S3 of the body 110 and is in contact with and electrically connected to the plurality of first internal electrodes 150.

In another embodiment, the first connection portion 210 may cover a portion of the third surface S3 of the body 110.

The first band portion 220 extends from the first connection portion 210 to cover at least a portion of the first surface S1, the second surface S2, the fifth surface S5, and the sixth surface S6 of the body 110. The first band portion 220 may ensure that the first external electrode 200 is more strongly adhered to the body 110.

The first band portion 220 may include a first sub-band portion 221, a second sub-band portion 222, a third sub-band portion 223, and a fourth sub-band portion 224.

The first sub-band portion 221 is disposed on the first surface S1 of the body 110, and the second sub-band portion 222 is disposed on the second surface S2 of the body 110. The first sub-band portion 221 and the second sub-band portion 222 may protrude in a direction parallel to the thickness direction (T-axis direction).

Furthermore, the third sub-band portion 223 is disposed on the fifth surface S5 of the body 110, and the fourth sub-band portion 224 is disposed on the sixth surface S6 of the body 110. The third sub-band portion 223 and the fourth sub-band portion 224 may protrude in a direction parallel to the width direction (W-axis direction).

The first sub-band portion 221, the second sub-band portion 222, the third sub-band portion 223, and the fourth sub-band portion 224 are connected to each other. In other words, the first sub-band portion 221, the second sub-band portion 222, the third sub-band portion 223, and the fourth sub-band portion 224 are connected along the first surface S1, the second surface S2, the third surface S3, and the fourth surface S4 of the body 110.

The first protruding portion 230 is disposed on the first band portion 220 and is spaced apart from the first connection portion 210.Furthermore, the first protruding portion 230 may be spaced apart from an edge of the first band portion 220 that is closer to the body 110. For example, the first protruding portion 230 may have a shape protruding between the edge of the first band portion 220 closer to the body 110 and the first connection portion 210.

Referring to FIG. 10, the first protruding portion 230 may be referred to as being “spaced apart” from the first connection portion 210 when an extension E of the third surface S3 of the body 110 does not pass through the first protruding portion 230. In other words, when the first protruding portion 230 is disposed more inwardly than the extension E of the third surface S3 in the length direction (L-axis direction) of the body 110, the first protruding portion 230 may be referred to as being “spaced apart” from the first connection portion 210. Alternatively, the first protruding portion 230 may be referred to as being “spaced apart” from the first connection portion 210 when there is a gap between the outer surface of the first protruding portion 230 closer to the third surface S3 and the extension E of the third surface S3.

Here, the extension E of the third surface S3 may be defined with reference to an optical microscope or scanning electron microscope (SEM) photograph of a cross section taken along the length direction (L-axis direction) and thickness direction (T-axis direction) at the center of the multilayer ceramic capacitor 1000 in the width direction (W-axis direction). In the above-described cross-sectional photograph, seven straight lines P0, P1, P2, P3, P4, P5, and P6 are drawn from the first surface S1 to the second surface S2 of the body 110, evenly spaced in the thickness direction (T-axis direction) and parallel to the length direction (L-axis direction), and the straight line passing through the point where P2 meets the third surface S3 and the point where P4 meets the third surface S3 may be defined as an extension E of the third surface S3. The above description may also be applied to the relationship between a second protruding portion 330 and a second connection portion 310.

The first protruding portion 230 may include a first sub-protruding portion 231, a second sub-protruding portion 232, a third sub-protruding portion 233, and a fourth sub-protruding portion 234.

The first sub-protruding portion 231 is disposed on the first sub-band portion 221, and the second sub-protruding portion 232 is disposed on the second sub-band portion 222. The third sub-protruding portion 233 is disposed on the third sub-band portion 223, and the fourth sub-protruding portion 234 is disposed on the fourth sub-band portion 224. The first sub-protruding portion 231, the second sub-protruding portion 232, the third sub-protruding portion 233, and the fourth sub-protruding portion 234 are connected to each other. In other words, the first sub-protruding portion 231, the second sub-protruding portion 232, the third sub-protruding portion 233, and the fourth sub-protruding portion 234 are connected along the first sub-band portion 221, the second sub-band portion 222, the third sub-band portion 223, and the fourth sub-band portion 224.

The first corner portion 240 may be a portion connecting the first connection portion 210 and the first band portion 220.

The second external electrode 300 includes a second connection portion 310, a second band portion 320, a second protruding portion 330, and a second corner portion 340.

The second connection portion 310 covers the fourth surface S4 of the body 110 and is in contact with and electrically connected to the plurality of second internal electrodes 160.

In another embodiment, the second connection portion 310 may cover a portion of the fourth surface S4 of the body 110.

The second band portion 320 extends from the second connection portion 310 to cover at least a portion of the first surface S1, the second surface S2, the fifth surface S5, and the sixth surface S6 of the body 110. The second band portion 320 may ensure the second external electrode 300 is more strongly adhered to the body 110.

The second band portion 320 may include a first sub-band portion 321, a second sub-band portion 322, a third sub-band portion 323, and a fourth sub-band portion 324.

The first sub-band portion 321 is disposed on the first surface S1 of the body 110, and the second sub-band portion 322 is disposed on the second surface S2 of the body 110. Furthermore, the third sub-band portion 323 is disposed on the fifth surface S5 of the body 110, and the fourth sub-band portion 324 is disposed on the sixth surface S6 of the body 110. The first sub-band portion 321, the second sub-band portion 322, the third sub-band portion 323, and the fourth sub-band portion 324 are connected to each other. In other words, the first sub-band portion 321, the second sub-band portion 322, the third sub-band portion 323, and the fourth sub-band portion 324 are connected along the first surface S1, the second surface S2, the third surface S3, and the fourth surface S4 of the body 110.

The second protruding portion 330 is disposed on the second band portion 320, and is spaced apart from the second connection portion 310. Furthermore, the second protruding portion 330 may be spaced apart from an edge of the second band portion 320 that is closer to the body 110. For example, the second protruding portion 330 may have a shape that protrudes between the edge of the second band portion 320 closer to the body 110 and the second connection portion 310.

The second protruding portion 330 may include a first sub-protruding portion 331, a second sub-protruding portion 332, a third sub-protruding portion 333, and a fourth sub-protruding portion 334.

The first sub-protruding portion 331 is disposed on the first sub-band portion 321, and the second sub-protruding portion 332 is disposed on the second sub-band portion 322. The third sub-protruding portion 333 is disposed on the third sub-band portion 323, and the fourth sub-protruding portion 334 is disposed on the fourth sub-band portion 324. The first sub-protruding portion 331, the second sub-protruding portion 332, the third sub-protruding portion 333 and the fourth sub-protruding portion 334 are connected to each other. In other words, the first sub-protruding portion 331, the second sub-protruding portion 332, the third sub-protruding portion 333 and the fourth sub-protruding portion 334 are connected along the first sub-band portion 321, the second sub-band portion 322, the third sub-band portion 323, and the fourth sub-band portion 324.

The second corner portion 340 may be a portion connecting the second connection portion 310 and the second band portion 320.

Referring to an optical microscope or scanning electron microscope (SEM) photograph of a cross section taken along the length direction (L-axis direction) and thickness direction (T-axis direction) at the center of the multilayer ceramic capacitor 1000 in the width direction (W-axis direction), in the multilayer ceramic capacitor 1000 shown in the above-mentioned cross section photograph, the first connection portion 210 and the second connection portion 310 may have a shape generally parallel to the thickness direction (T-axis direction), the first band portion 220 and the second band portion 320 may have a shape generally parallel to the length direction (L-axis direction), and the first corner portion 240 and the second corner portion 340 may have a curved line shape. The above-described curved line shape may be one having a tangent whose slope changes from a direction parallel to the thickness direction (T-axis direction) to a direction parallel to the length direction (L-axis direction), or in the opposite direction.

For example, the first external electrode 200 and the second external electrode 300 may include a conductive material such as copper (Cu), aluminum (Al), silver (Ag), tin (Sn), gold (Au), nickel (Ni), lead (Pb), chromium (Cr), titanium (Ti), or an alloy thereof, but are not limited thereto.

As another example, the first external electrode 200 and the second external electrode 300 may include both metal and glass. For example, the metal may be a conductive metal including copper (Cu), nickel (Ni), tin (Sn), palladium (Pd), platinum (Pt), gold (Au), silver (Ag), tungsten (W), titanium (Ti), lead (Pb), or an alloy thereof. The glass component included in the external electrode may be a mixture of oxides. The glass component may include, for example, a silicon oxide, a boron oxide, an aluminum oxide, a transition metal oxide, an alkali metal oxide, an alkaline-earth metal oxide, or a combination thereof. Here, the transition metal may be selected from zinc (Zn), titanium (Ti), copper (Cu), vanadium (V), manganese (Mn), iron (Fe), or nickel (Ni), the alkali metal may be selected from lithium (Li), sodium (Na), or potassium (K), and the alkaline-earth metal may be selected from magnesium (Mg), calcium (Ca), strontium (Sr), or barium (Ba). The method of forming the external electrode may not be particularly limited. For example, the external electrode may be formed by dipping a body in a conductive paste containing metal and glass, or by printing a conductive paste on a surface of the body by, e.g., screen printing, gravure printing, or the like. Alternatively, various methods such as applying a conductive paste on the surface of the body or transferring a dry film formed by drying a conductive paste to a body, may be used.

Meanwhile, the first external electrode 200 and the second external electrode 300 may be covered by a plating layer. The plating layer may include a nickel (Ni) plating layer, a copper (Cu) plating layer, a tin (Sn) plating layer, etc. For example, the plating layer may be disposed on the surface of the external electrode 200 or 300 in the order of a nickel (Ni) plating layer, a copper (Cu) plating layer, and a tin (Sn) plating layer, but the present embodiment is not limited thereto.

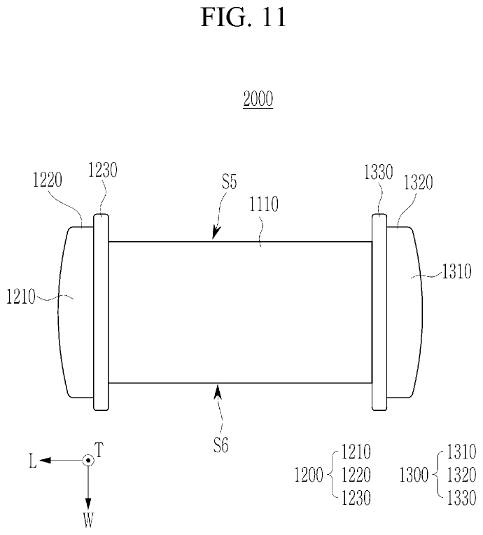

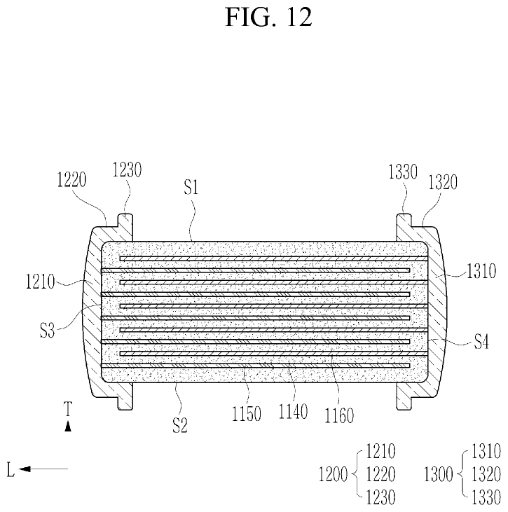

FIG. 11 is a plan view schematically illustrating a multilayer ceramic capacitor according to another embodiment, and FIG. 12 is a schematic cross-sectional view of FIG. 11.

Referring to FIGS. 11 and 12, a multilayer ceramic capacitor 2000 may include a body 1110, a first external electrode 1200, and a second external electrode 1300.

The body 1110 may include a plurality of dielectric layers 1140, a first internal electrode 1150, and a second internal electrode 1160.

The first external electrode 1200 includes a first connection portion 1210, a first band portion 1220, and a first protruding portion 1230.

The first protruding portion 1230 is disposed on the first band portion 1220 and is spaced apart from the first connection portion 1210. The first protruding portion 1230 may be disposed on an edge of the first band portion 1220 that is closer to the body 110. For example, the edge of the first protruding portion 1230 closer to the body 110 may not be distinguishable from the edge of the first band portion 1220 closer to the body 110.

The second external electrode 1300 includes a second connection portion 1310, a second band portion 1320, and a second protruding portion 1330.

The second protruding portion 1330 is disposed on the second band portion 1320 and is spaced apart from the second connection portion 1310. The second protruding portion 1330 may be disposed on an edge of the second band portion 1320 that is closer to the body 110. For example, the edge of the second protruding portion 1330 closer to the body 110 may not be distinguishable from the edge of the second band portion 1320 closer to the body 110.

The other constituent elements except for the above are identical or correspond to the constituent elements of the multilayer ceramic capacitor shown in FIG. 1, and thus, a redundant description thereof will be omitted.

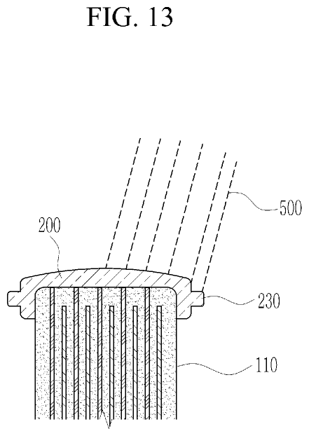

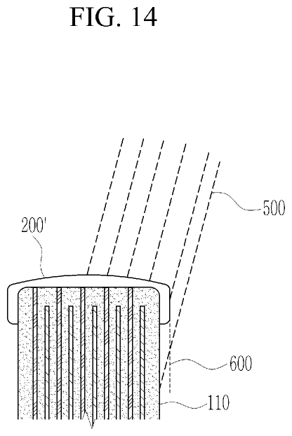

FIG. 13 is a schematic view illustrating a process of forming a coating layer on a multilayer ceramic capacitor according to an example, and FIG. 14 is a view schematically illustrating a process of forming a coating layer on a multilayer ceramic capacitor according to a comparative example.

Referring to FIG. 13, the protruding portion 230 is disposed on the external electrode 200 of the multilayer ceramic capacitor according to an example, such that a coating material 500 does not spread to the body 110. Therefore, according to the present embodiment, a mooning phenomenon may be prevented.

In contrast, referring to FIG. 14, no protruding portion is disposed on an external electrode 200′ of the multilayer ceramic capacitor according to a comparative example. Accordingly, a coating material 500 may spread to a body 110′, resulting in a mooning phenomenon in which a coating layer 600 is formed in unwanted areas.

While this disclosure has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

1000: Multilayer Ceramic Capacitor
110: Body
200: First External Electrode
210: First Connection portion
220: First Band Portion
230: First Protruding Portion
300: Second External Electrode
310: Second Connection portion
320: Second Band Portion
330: Second Protruding Portion
140: Dielectric Layer
143: First Cover Layer
145: Second Cover Layer
150: First Internal Electrode
160: Second Internal Electrode

What is claimed is:

1. A multilayer ceramic capacitor comprising:
a body that includes a first surface and second surface which oppose each other in a first direction, a third surface and a fourth surface which oppose each other in a second direction intersecting the first direction, and a fifth surface and a sixth surface which oppose each other in a third direction intersecting both of the first direction and the second direction, and includes a plurality of dielectric layers and a plurality of internal electrodes stacked in the first direction; and
an external electrode that is disposed outside the body,
wherein the external electrode includes
a connection portion that is connected to the plurality of internal electrodes;
a band portion that is connected to the connection portion and covers a portion of each of the first surface, the second surface, the fifth surface, and the sixth surface; and
a protruding portion that is spaced apart from the connection portion and is disposed on the band portion on each of the first surface, the second surface, the fifth surface, and the sixth surface.

2. The multilayer ceramic capacitor of claim 1, wherein
the protruding portion is spaced apart from an edge of the band portion that is closer to the body.

3. The multilayer ceramic capacitor of claim 1, wherein
the protruding portion is disposed on an edge of the band portion that is closer to the body.

4. The multilayer ceramic capacitor of claim 1, wherein
the band portion includes
a first sub-band portion on the first surface;
a second sub-band portion on the second surface;
a third sub-band portion on the fifth surface; and
a fourth sub-band portion on the sixth surface, and
the protruding portion includes
a first sub-protruding portion that is disposed on the first sub-band portion;
a second sub-protruding portion that is disposed on the second sub-band portion;
a third sub-protruding portion that is disposed on the third sub-band portion; and
a fourth sub-protruding portion that is disposed on the fourth sub-band portion, and
the first sub-protruding portion, the second sub-protruding portion, the third sub-protruding portion, and the fourth sub-protruding portion are connected to each other.

5. The multilayer ceramic capacitor of claim 4, wherein
the first sub-protruding portion and the second sub-protruding portion protrude in a direction parallel to the first direction.

6. The multilayer ceramic capacitor of claim 4, wherein
the third sub-protruding portion and the fourth sub-protruding portion protrude in a direction parallel to the third direction.

7. The multilayer ceramic capacitor of claim 1, wherein
the external electrode further includes a corner portion that connects the connection portion and the band portion.

8. The multilayer ceramic capacitor of claim 1, wherein
the plurality of internal electrodes includes a plurality of first internal electrodes and a plurality of second internal electrodes disposed in a staggered manner in the first direction.

9. The multilayer ceramic capacitor of claim 8, wherein
the external electrode includes
a first external electrode that is disposed on the third surface and connected to the plurality of first internal electrodes; and
a second external electrode that is disposed on the fourth surface and connected to the plurality of second internal electrodes.
